(19) United States
(12) Patent Application Publication
(10) Pub. No.: US 2025/0167691 A1
(43) Pub. Date: May 22, 2025

(54) LAGGING LEG ELIMINATION PHASE-SHIFT FULL-BRIDGE CONVERTER CIRCUIT

(71) Applicant: SK SIGNET INC., Jeollanam-do (KR)

(72) Inventors: Je Hyun YI, Gimpo-si Gyeonggi-do (KR); Hyun Jae YOO, Suwon-si Gyeonggi-do (KR); Jeong Jun SEO, Seoul (KR)

(21) Appl. No.: 18/871,827

(22) PCT Filed: Nov. 25, 2022
(86) PCT No.: PCT/KR2022/018779

§ 371 Date: Dec. 5, 2024

(30) Foreign Application Priority Data
Oct. 31, 2022 (KR) 10-2022-0143188

(51) Int. Cl. H02M 3/335; H02M 1/00; H02M 3/28

(52) U.S. Cl. CPC H02M 3/33573; H02M 1/0043; H02M 1/0058; H02M 3/285

(57) ABSTRACT

Disclosed is a lagging leg removal phase shift full bridge converter circuit. The circuit may include: a primary circuit including Leg 1, Leg 2, Leg 3, and Leg 4, applying a switching control signal to a switch included in each leg, and switching the switching control signal to output a first AC voltage; a secondary circuit including a plurality of modules which transforms the first AC voltage into a second AC voltage according to a predetermined transform ratio, and performs rectification and filtering for the second AC voltage; and a controller generating the switching control signal, and supplying the generated switching control signal to the switch included in each leg.

### TECHNICAL FIELD

The present invention relates to a lagging leg removal phase shift full bridge converter circuit. More particularly, the present invention relates to a phase shift full bridge converter circuit serving as a lagging leg while a leg is a leading leg through overlapping of a switching signal.

### BACKGROUND ART

A full bridge is widely used as a large-capacity power conversion circuit. FIG. 1 is a conventional phase shift full bridge converter circuit. Referring to FIG. 1, the phase shift full bridge converter circuit is configured to include a primary circuit that generates and delivers a voltage by switching applied signals in switches S1 to S4, and a secondary circuit that transforms a primary generation voltage, and performs rectification and filtering.

FIG. 2 illustrates an example of a switching control signal applied to each switch of the phase shift full bridge converter of FIG. 1. Referring to FIG. 2, the switching control signal applied to each switch has a duty ratio of 50% compared with a period Ts, complementarily operates switches S1 and S2, and also complementarily operates switches S3 and S4. In particular, in the primary circuit, when a phase is shifted as compared with S1, and S4 is thus turned simultaneously with S1 during an interval of a phase angle θ or the phase is shifted as compared with S2, and S3 is thus turned simultaneously during a predetermined phase angle interval with S2, the voltage is delivered to a secondary side.

Here, when a leg which is turned first is defined as a leading leg and a leg which is turned later is defined as a lagging leg, the leading leg soft-switching operates by energy of a secondary-side inductor, and the lagging leg soft-switching operates by a parasite inductance of a primary transformer.

A phase shift full bridge is a circuit that has a lot of advantages such as a large-capacity reliability and manipulation easiness, but there is a problem in that in the lagging leg, the soft switching operation is difficult unlike the leading leg. It may be considered that a leakage inductance value is increased in order to solve such a problem, but such a scheme causes another duty cycle loss in which an actual energy delivery interval is reduced.

Therefore, a method for guaranteeing a wide zero-voltage switching region by adding a separate auxiliary circuit to a converter is disclosed, but such a method also has a limit that circuit lightweightening and miniaturization are harmed due to design and application of the auxiliary circuit.

### PRIOR PATENT DOCUMENT

Korean Patent Publication No. 10-2011-0064605

### DISCLOSURE

### Technical Problem

A technical object to be achieved by the present invention is to provide a phase shift full bridge converter circuit which is operable by soft switching in most operating regions without a separate additional circuit.

Specifically, a technical object to be achieved by the present invention is to provide a phase shift full bridge converter which is operable by soft switching in almost all load intervals from a low load by converting all legs into a leading leg without a separate auxiliary circuit.

Further, a technical object to be achieved by the present invention is to solve a problem in that an energy delivery interval is reduced by minimizing a value of a leakage inductor.

The technical objects of the present invention are not restricted to the aforementioned technical objects, and other objects of the present invention, which are not mentioned above, will become more apparent to one of ordinary skill in the art to which the present invention pertains by referencing the detailed description of the present invention given below.

### Technical Solution

In order to achieve the objects, a lagging leg removal phase shift full bridge converter circuit according to an embodiment of the present invention may include: a primary circuit including Leg 1, Leg 2, Leg 3, and Leg 4, applying a switching control signal to a switch included in each leg, and switching the switching control signal to output a first AC voltage; a secondary circuit including a plurality of modules which transforms the first AC voltage into a second AC voltage according to a predetermined transform ratio, and performs rectification and filtering for the second AC voltage; and a controller generating the switching control signal, and supplying the generated switching control signal to the switch included in each leg.

In an embodiment, the plurality of modules may include a first module, a second module, a third module, and a fourth module, and as Leg 1 and Leg 2 operate, the first module may be driven, as Leg 2 and Leg 3 operate, the second module may be driven, as Leg 3 and Leg 4 operate, the third module may be driven, and as Leg 4 and Leg 1 operate, the fourth module may be driven.

In an embodiment, Leg 1 may include a first switch and a second switch connected in series, Leg 2 may include a third switch and a fourth switch connected in series, Leg 3 may include a fifth switch and a sixth switch connected in series, and Leg 4 may include a seventh switch and an eighth switch connected in series.

In an embodiment, Leg 1 may operate as a leading leg and Leg 2 may operate as a lagging leg in order to drive the first module, Leg 2 may operate as the leading leg and Leg 3 may operate as the lagging leg in order to drive the second module, Leg 3 may operate as the leading leg and Leg 3 may operate as the lagging leg in order to drive the third module, and Leg 4 may operate as the leading leg and Leg 1 may operate as the lagging leg in order to drive the fourth module.

In an embodiment, Leg 1 may operate as the leading leg with respect the first module during a first interval of the switching control signal, and operate as the lagging leg with respect to the fourth module during a second interval different from the first interval.

In an embodiment, a first interval of a switching control signal for turning on the switch of each leading leg may be overlapped to be advanced by a phase angle of 90 degrees as compared with a second interval of a switching control signal for turning on the switch of each lagging leg which matches each leading leg.

In an embodiment, a duty ratio of the switching control signal may be 50%. In an embodiment, the controller may generate a switching control signal which allows the dead time between the switching control signals supplied to the switches included in each of Leg 1, Leg 2, Leg 3, and Leg 4 to have the same time interval.

### Advantageous Effects

According to an embodiment of the present invention, a lagging leg removing phase shift full bridge converter has an advantage in that a soft switching range is significantly enhanced due to an effect of removing a lagging leg. Specifically, all legs are constituted by a leading leg and a lagging leg, so the soft switching range is widened.

According to an embodiment of the present invention, an operation for power conversion is performed by all elements without an additional circuit for a soft switching operation, so efficiency of a circuit design is increased. Further, current applied to each switch is offset, so a gain is generated in terms of conduction loss.

According to an embodiment of the present invention, a leakage inductance value can be minimized, so there is an effect of significantly reducing duty cycle loss. Specifically, an additionally connected inductor disappears by designing the leakage inductance value to the minimum, which is advantageous in circuit lightweightening and miniaturization. As a result, there is also an advantage in that an energy delivery interval can be maximally secured.

According to an embodiment of the present invention, efficiency of the circuit can be maximized due to an advantage in that soft switching is available in almost all load regions and an effect of reducing conduction loss due to current offset upon operating each switch.

The effects of the present invention are not limited to the aforementioned effect, and other effects, which are not mentioned above, will be apparent to a person having ordinary skill in the art from the following disclosure.

### DESCRIPTION OF DRAWINGS

FIG. 1 is a conventional full bridge converter circuit.

FIG. 2 illustrates an example of a switching control signal applied to each switch of the full bridge converter of FIG. 1.

FIG. 3 illustrates an example of a lagging leg removing phase shift full bridge converter circuit according to an embodiment of the present invention.

FIG. 4 illustrates an example of a 4 parallel switch overlapped phase shift full bridge converter circuit referenced in some embodiments of the present invention.

FIG. 5 illustrates an example for describing a combination of a leading leg and a lagging leg referenced in some embodiments of the present invention.

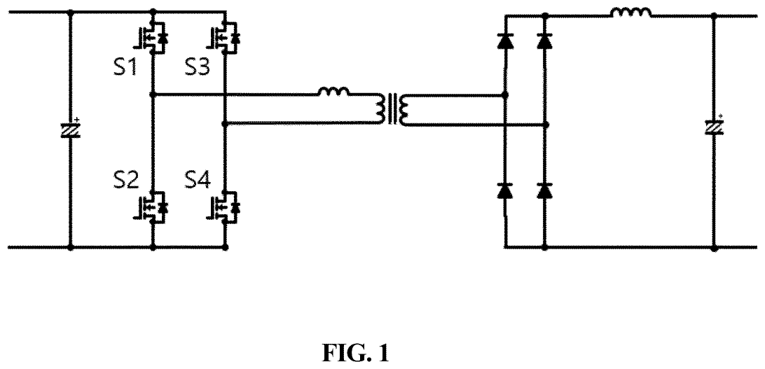

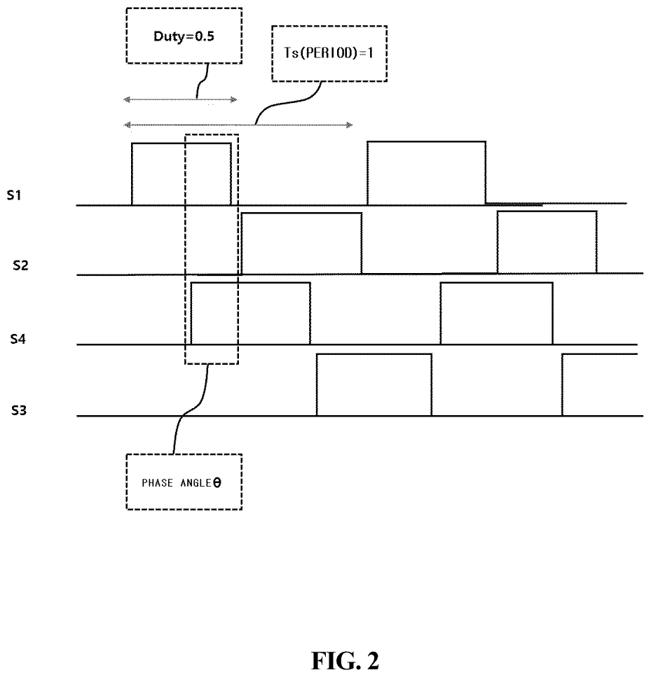

### BEST MODE

Hereinafter, preferred embodiments of the present invention will be described in detail with reference to the accompanying drawings. Advantages and features of the present invention, and methods for accomplishing the same will be more clearly understood from embodiments described in detail below with reference to the accompanying drawings. However, the present invention is not limited to the embodiments set forth below, and may be embodied in various different forms. The present embodiments are just for rendering the disclosure of the present invention complete and are set forth to provide a complete understanding of the scope of the invention to a person with ordinary skill in the technical field to which the present invention pertains, and the present invention will only be defined by the scope of the claims. Throughout the whole specification, the same reference numerals denote the same elements.

Unless otherwise defined, all terms (including technical and scientific terms) used in the present specification may be used as the meaning which may be commonly understood by the person with ordinary skill in the art, to which the present invention pertains. Terms defined in commonly used dictionaries should not be interpreted in an idealized or excessive sense unless expressly and specifically defined. It is also to be understood that the terminology used herein is for the purpose of describing embodiments only and is not intended to limit the present invention. In the present specification, the singular form also includes the plural form, unless the context indicates otherwise.

Hereinafter, a lagging leg removing phase shift full bridge converter circuit according to an embodiment of the present invention may be abbreviated as a lagging leg removing circuit.

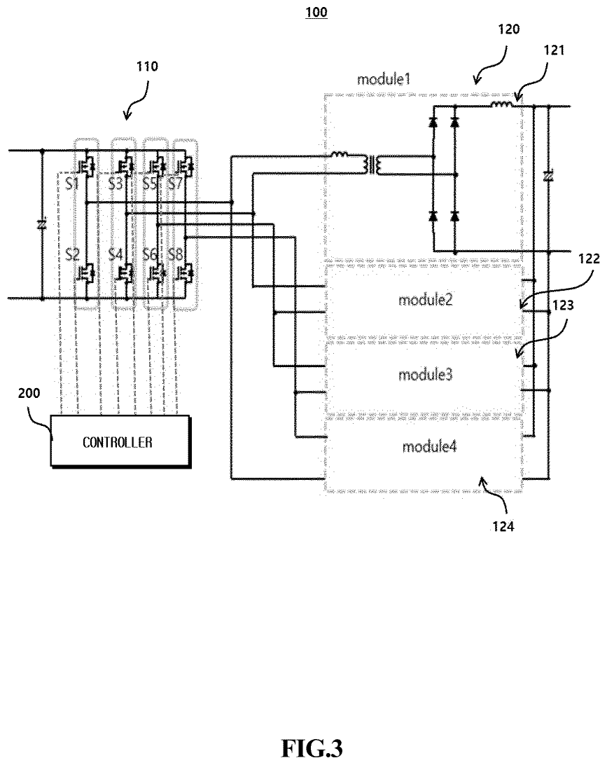

FIG. 3 illustrates an example of a lagging leg removing phase shift full bridge converter circuit according to an embodiment of the present invention.

Referring to FIG. 3, the lagging leg removing circuit 100 may include a primary circuit 110, a secondary circuit 120, and a controller 200.

The primary circuit 110 includes a first switch S1, a second switch S2, a third switch S3, a fourth switch S4, a fifth switch S5, a sixth switch S6, a seventh switch S7, and an eighth switch S8.

In an embodiment, a switching control signal may be applied to a gate terminal of each switch of the primary circuit 110 from the controller 200.

The primary circuit 110 applies the switching control signal to each switch, and switches the switching control signal to output a first AC voltage. In FIG. 3, the primary circuit 110 may output the first AC voltage to a transformer include in each module of the secondary circuit 120.

The secondary circuit 120 includes a plurality of modules, in particular, in FIG. 3, a case where the secondary circuit 120 includes module 1 121, module 122, module 3 123, and module 4 124 is illustrated as an example. Respective modules are configured to be connected in parallel to each other.

Each of the plurality of modules includes the transformer to transform the first AC voltage which is an output of the primary circuit 110 into a second AC voltage according to a predetermined transform ratio. Further, each module may perform rectification and filtering for the second AC voltage.

To this end, each module includes a rectification unit and a filter unit.

The rectification unit is configured to include a parallel combination of a plurality of diodes, and the filter unit may be configured to include at least one inductor and at least one capacitor.

The rectification unit and the filter unit according to the embodiment of the present invention are not limited to the disclosure, and a circuit design scheme widely known to a technical field to which the present invention belongs, or an application embodiment thereof may be applied to the rectification unit and filter unit configuration.

The controller 200 generates the switching control signal for controlling the switching operations of the first switch S1 to the eighth switch S8 of the primary circuit 110 and delivers the generated switching control signal to the primary circuit 110. The controller 200 may be configured to include at least one processor widely known in the technical field to which the present invention belongs.

For example, the controller 200 may be implemented as an analog circuit or a digital circuit. According to an embodiment, when the controller 200 is implemented as the analog circuit, it is possible to simply design the controller according to the embodiment of the present invention by using only one PWM IC.

Further, since the lagging leg removing circuit according to the embodiment of the present invention is driven by four parallel circuits, front and rear phase angles in which overlapping occurs between the respective switching control signals may be set to be equal to each other. Therefore, even when the controller 200 according to the embodiment of the present invention is implemented as the digital circuit, it is possible to apply a processor having a low cost and a low specification by setting the same phase angle.

### MODE FOR INVENTION

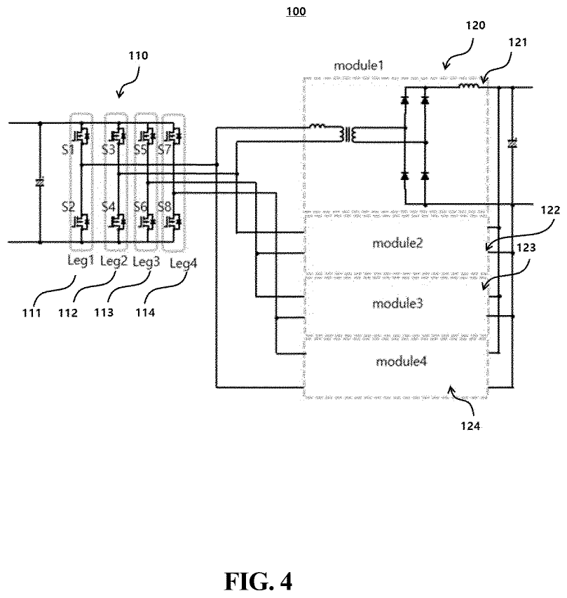

FIG. 4 illustrates an example of a 4 parallel switch overlapped phase shift full bridge converter circuit referenced in some embodiments of the present invention.

In FIG. 4, the controller 200 of FIG. 3 is omitted, but it is assumed that the switching control signal by the controller 200 is applied to the primary circuit 110.

Referring to FIG. 4, the lagging leg control circuit 100 includes Leg 1 111, Leg 2 112, Leg 3 113, and Leg 4 114.

Leg 1 111 may include the first switch S1 and the second switch S2 connected in series, Leg 2 112 may include the third switch S3 and the fourth switch S4 connected in series, Leg 3 113 may include the fifth switch S5 and the sixth switch S6 connected in series, and Leg 4 114 may include the seventh switch S7 and the eighth switch S8 connected in series.

Referring to FIG. 4, two legs of the primary circuit 110 and one module of the secondary circuit 12 are connected in parallel, so a total of four pairs of parallel circuits are driven according to the switching control signal of the controller 200.

Specifically, as Leg 1 111 and Leg 2 112 operate, a first module 121 may be driven, as Leg 2 112 and Leg 3 113 operate, a second module 122 may be driven, as Leg 3 113 and Leg 4 114 operate, a third module 123 may be driven, and as Leg 4 114 and Leg 1 111 operate, a fourth module 124 may be driven.

In this case, when the leading leg and the lagging leg are described for each module according to an order in which the module is turned earlier, Leg 1 111 operates as the leading leg and Leg 2 112 operates as the lagging leg in order to drive the first module 121.

Leg 2 112 operates as the leading leg and Leg 3 113 operates as the lagging leg in order to drive the second module 122. That is, Leg 2 112 operates during different duty intervals of the switching control signal to drive the first module 121 and the second module 122.

Leg 3 113 operates as the leading leg and Leg 4 114 operates as the lagging leg in order to drive the third module 123. That is, Leg 3 113 operates during different duty intervals of the switching signal to drive the second module 122 and the third module 123. Leg 3 114 operates as the leading leg and Leg 1 111 operates as the lagging leg in order to drive the fourth module 124. That is, Leg 4 114 operates during different duty intervals of the switching signal to drive the third module 123 and the fourth module 124.

Meanwhile, Leg 1 111 operates as the leading leg in order to drive the first module 121, and operates as the lagging leg in order to drive the fourth module 124 as described above.

The controller 200 generates the switching control signal for driving each leg and the switch included in each leg as described above, and delivers the generated switching control signal to the primary circuit 110.

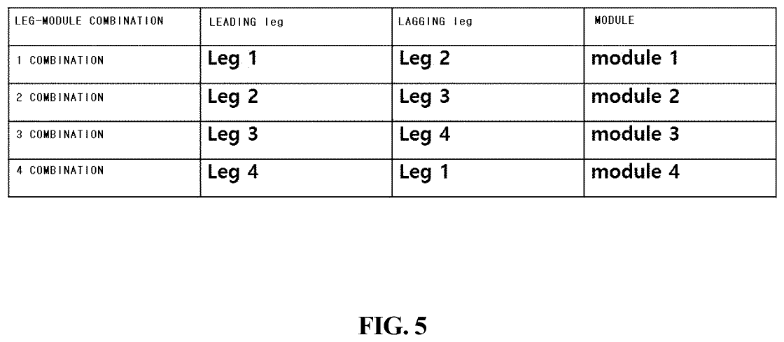

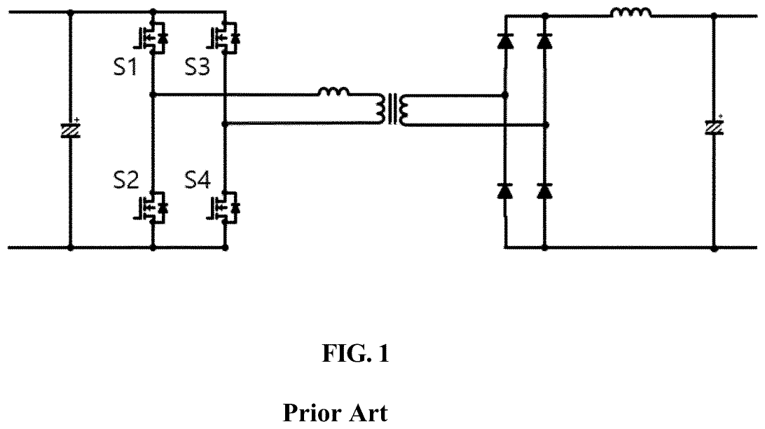

FIG. 5 illustrates an example for describing a combination of a leading leg and a lagging leg referenced in some embodiments of the present invention.

Referring to FIG. 5, in a combination of the leg and the module, by coupling first to fourth combinations, each leg may operate as the leading leg with respect to any one module, and operate as the lagging leg with respect to the other one module.

As a result, a problem in which soft switching which occurs as a specific leg remains as the lagging leg becomes difficult may be resolved.

In particular, even in a combination of pairs of each module and the leg, when there is the leg which operates only as the lagging leg, a value of a leakage inductance cannot but be brought at any degree at the time of designing the corresponding module to which the lagging leg is applied.

In this case, a soft switching driving condition between a plurality of modules varies, and as a result, design values of the modules such as the leakage inductance value and a dead time also vary. This may cause another problem such as an imbalance of current which passes through an element.

On the contrary, according to the embodiment of the present invention, there is an advantage in that when each module is operated by coupling the first to fourth combinations in parallel, so the design values may be maintained to be equal to each other as a lagging leg for any one module operates as a leading leg for the other module.

As a result, the controller 200 may generate a switching control signal which allows the dead time between the switching control signals supplied to the switches S1 to S8 included in each of Leg 1 111, Leg 2 112, Leg 3 113, and Leg 4 114 to have the same time interval.

Further, according to the embodiment of the present invention, a first interval of a switching control signal for turning on the switch of each leading leg may be overlapped to be advanced by a phase angle of 90 degrees as compared with a second interval of a switching control signal for turning on the switch of each lagging leg which matches each leading leg.

According to the embodiment of the present invention, the controller 200 may generate a duty ratio of the switching control signal as 50%.

The methods for generating the switching control signal of the controller 200 according to the embodiment of the present invention described with reference to the accompanying drawings so far can be performed by executing a computer program implemented in computer-readable code. The computer program may be transmitted from a first computing apparatus to a second computing apparatus through a network such as the Internet and installed in the second computing apparatus to be used in the second computing apparatus. The first computing apparatus and the second computing apparatus include all of a server apparatus, a fixed computing apparatus such as a desktop PC, and a mobile computing apparatus such as a notebook, a smart phone, and a tablet PC.

Hereinabove, the embodiments of the present invention have been described with the accompanying drawings, but it can be understood by those skilled in the art that the present invention can be executed in other detailed forms without changing the technical spirit or requisite features of the present invention. Therefore, it should be appreciated that the aforementioned embodiments are illustrative in all aspects and are not restricted.

### INDUSTRIAL APPLICABILITY

The present invention is applicable in a power conversion industry.

1-8. (canceled)

9. A lagging leg removal phase shift full bridge converter circuit comprising:
a primary circuit including Leg 1, Leg 2, Leg 3, and Leg 4, applying a switching control signal to a switch included in each leg, and switching the switching control signal to output a first AC voltage;
a secondary circuit including a first module, a second module, a third module, and a fourth module which transform the first AC voltage into a second AC voltage according to a predetermined transform ratio, and performs rectification and filtering for the second AC voltage; and
a controller generating the switching control signal, and supplying the generated switching control signal to the switch included in each leg,
as the Leg 1 operates as a leading leg and the Leg 2 operates as a lagging leg, the first module is driven,
as the Leg 2 operates as the leading leg and the Leg 3 operates as the lagging leg, the second module is driven,
as the Leg 3 operates as the leading leg and the Leg 4 operates as the lagging leg, the third module is driven, and
as the Leg 4 operates the leading leg and the Leg 1 operates as the lagging leg, the fourth module is driven,
each of the first module, the second module, the third module, and the fourth module in the secondary circuit includes a first diode and a second diode connected in parallel, and a third diode and a fourth diode connected, in series, to the first diode and the second diode, respectively, and
a contact point at which the first diode and the third diode are connected in series is connected to one end of a transformer included in the each module, and a contact point at which the second diode and the fourth diode are connected in series is connected to the other end of the transformer.

10. The lagging leg removal phase shift full bridge converter circuit of claim 9, wherein the Leg 1 includes a first switch and a second switch connected in series,
the Leg 2 includes a third switch and a fourth switch connected in series,
the Leg 3 includes a fifth switch and a sixth switch connected in series, and
the Leg 4 includes a seventh switch and an eighth switch connected in series.

11. The lagging leg removal phase shift full bridge converter circuit of claim 9, wherein the Leg 1 operates as the leading leg with respect the first module during a first interval of the switching control signal, and operates as the lagging leg with respect to the fourth module during a second interval different from the first interval.

12. The lagging leg removal phase shift full bridge converter circuit of claim 9, wherein a first interval of a switching control signal for turning on the switch of each leading leg is overlapped to be advanced by a phase angle of 90 degrees as compared with a second interval of a switching control signal for turning on the switch of each lagging leg which matches each leading leg.

13. The lagging leg removal phase shift full bridge converter circuit of claim 12, wherein a duty ratio of the switching control signal is 50%.

14. The lagging leg removal phase shift full bridge converter circuit of claim 9, wherein the controller generates a switching control signal which allows the dead time between the switching control signals supplied to the switches included in each of the Leg 1, the Leg 2, the Leg 3, and the Leg 4 to have the same time interval.
